(19) United States
(12) Patent Application Publication
(10) Pub. No.: US 2011/0317541 A1
(43) Pub. Date: Dec. 29, 2011

(54) Block Interleaving Method and Block Interleaver Using the Same

(76) Inventors: Yen-Chin Liao, Taipei City (TW); Yung-Szu Tu, New Taipei City (TW); Cheng-Hsuan Wu, Taipei City (TW)

(21) Appl. No.: 13/082,430

(22) Filed: Apr. 8, 2011

Related U.S. Application Data
(60) Provisional application No. 61/358,915, filed on Jun. 27, 2010.

(30) Foreign Application Priority Data
Dec. 28, 2010 (TW) 099146235

(51) Int. Cl. H04J 11/00; H04W 84/02

(52) U.S. Cl. 370/203

(57) ABSTRACT

A block interleaving method for interleaving data of a transmitter in a wireless communication system is disclosed. The wireless communication system supports a multi-input multi-output (MIMO) technique for transmitting data via a plurality of spatial streams. The block interleaving method includes when the transmitter transmits a plurality of data through the MIMO technique, determining an order of the plurality of data according to the following equation,

$$r = ( j - ( ( ( {i}_{SS} - 1 ) \times M ) mod q + q \times floor ( \frac{{i}_{SS} - 1}{q} ) ) \times {N}_{ROT} {\times }_{BPSCS} ( {i}_{SS} ) ) {mod N}_{CBPSS} ( {i}_{SS} ) ;$$

$$j = 0 , 1 , … , {N}_{CBPSS} ( {i}_{SS} ) - 1 ;$$

$$M = 1 , 2 , … , q - 1.$$

### CROSS REFERENCE TO RELATED APPLICATIONS

This application claims the benefit of U.S. Provisional Application No. 61/358,915, filed on Jun. 27, 2010 and entitled “METHOD FOR INTERLEAVING AND INTERLEAVER USING THE SAME”, the contents of which are incorporated herein in their entirety.

### BACKGROUND OF THE INVENTION

1. Field of the Invention

The present invention relates to a block interleaving method and block interleaver, and more particularly, to a block interleaving method and block interleaver for a wireless local area network (WLAN) with a very high throughput.

2. Description of the Prior Art

In a wireless communication system, a signal is transmitted in a wireless channel which is affected by a large amount of noise and imperfect factors. Thus, for ensuring the signal transmitted by a transmitter to be correctly received by a receiver, various techniques have been developed to recover or avoid effects of noise or environmental factors.

Take Wireless Local Area Network (WLAN) as an example, according to WLAN standards developed by the Institute of Electrical and Electronics Engineers (IEEE), such as IEEE 802.11a, IEEE802.11b, IEEE802.11g and IEEE 802.11n which is a current mainstream, an interleaver and a deinterleaver are installed in the transmitter and the receiver, respectively. The interleaver scrambles coded data according to a predefined rule, to avoid a burst error during a transmission of the coded data. Correspondingly, the deinterleaver recovers an order of the coded data, to obtain the correct data. In short, the interleaver breaks the burst error such that the transmitted data can be obtained, since an amount of error bits caused by the burst error is limited.

The interleaver used in the IEEE 802.11 series is a block interleaver, a basic principle of the interleaver is writing a data sequence row-by-row into an N×M matrix, and reads the data sequence column-by-column out the N×M matrix. The detail approach is assuming that an order of the data in the data sequence, i.e., an index, is k, reordering the index k as i, and reordering the sequence of the index i as the sequence of an index j. Also, when more than one antenna is used (e.g. in an IEEE 802.11n system), a frequency rotation is further performed, and the index j of other antennas is replaced by r. Definition and decision of the indices i, j and r are represented as follows:

$$i = {N}_{ROW} ( k {mod N}_{COL} ) + floor ( k \text{/} {N}_{COL} ) \\ k = 0 , 1 , … , {N}_{CBPSS} ( {i}_{SS} ) - 1 \\ j = s ( {i}_{SS} ) \times floor ( i \text{/} s ( {i}_{SS} ) ) + ( i + {N}_{CBPSS} s ( {i}_{SS} ) - floor ( {N}_{COL} \times i \text{/} {N}_{CBPSS} s ( {i}_{SS} ) ) ) mod s ( {i}_{SS} ) \\ i = 0 , 1 , … , {N}_{CBPSS} ( {i}_{SS} ) - 1 \\ r = ( j - ( ( ( {i}_{SS} - 1 ) \times 2 ) mod 3 + 3 \times floor ( \frac{{i}_{SS} - 1}{3} ) ) \times {N}_{ROT} \times {N}_{BPSCS} ( {i}_{SS} ) ) {mod N}_{CBPSS} ( {i}_{SS} ) \\ j = 0 , 1 , … , {N}_{CBPSS} ( {i}_{SS} ) - 1 \text{:} \qquad ( Eq . 1 )$$

where i_{SS} is an ith spatial stream;

s(i_{SS})=max(N_{BPSCS}(i_{SS})/2,1);

floor(*) is a floor function for rounding down;

N_{ROW} is a number of row in the interleaver;

N_{COL} is a number of column in the interleaver;

N_{BPSCS}(i_{SS}) is a number of coded bits of each single carrier of the ith spatial stream;

N_{CBPSS}(i_{SS}) is a number of coded bits of each symbol of the ith spatial stream, i.e., N_{CBPSS}(i_{SS})=N_{DATA}×N_{BPSCS}(i_{SS}), and N_{DATA} is a number of carriers; and

N_{ROT} is a frequency rotation factor. N_{ROT} is 11 when a channel bandwidth is 20 MHz, and N_{ROT} is 29 when the channel bandwidth is 40 MHz.

The index r is a cyclic shift value of the spatial stream. Since the IEEE 802.11n supports up to 4 antennas, i.e., a data block is divided into 4 data subblocks and 4 spatial streams are respectively allocated, after the frequency rotation, rotation values of the 4 spatial streams in the IEEE 802.11n can be represented by a table 10 shown in FIG. 1. For simplicity, the rotation values in the table 10 are multiples of (N_{ROT}×N_{BPSCS}(i_{SS})).

On the other hand, for achieving a higher transmission throughput, the IEEE committee creates a new generation IEEE 802.11ac standard, which is a very high throughput (VHT) standard. The IEEE 802.11ac standard utilizes a bandwidth greater than a legacy bandwidth of 40 MHz (e.g. 80 MHz), and supports up to 8 antennas. In this situation, a conventional interleaver structure in the IEEE 802.11n standard is not completely applicable, especially the index r when using more than one antenna. Therefore, it is necessary to develop a decision method of the index r suitable for the IEEE 802.11ac standard.

### SUMMARY OF THE INVENTION

It is therefore a primary objective of the present invention to provide a block interleaving method and block interleaver.

The present invention discloses a block interleaving method in a wireless communication system, for interleaving data transmitted by a transmitter. The wireless communication system supports a multi-input multi-output (MIMO) technique for transmitting data via a plurality of spatial streams. The block interleaving method comprises, when the transmitter transmits a plurality of data through the MIMO technique, determining an order of the plurality of data according to the following equation,

$$r = ( j - ( ( ( {i}_{SS} - 1 ) \times M ) mod q + q \times floor ( \frac{{i}_{SS} - 1}{q} ) ) \times {N}_{ROT} \times {N}_{BPSCS} ( {i}_{SS} ) ) {mod N}_{CBPSS} ( {i}_{SS} ) ;$$

$$j = 0 , 1 , … , {N}_{CBPSS} ( {i}_{SS} ) - 1 ;$$

$$M = 1 , 2 , … , q - 1 ;$$

wherein i_{SS} is an ith spatial stream of the plurality of spatial streams; s(i_{SS})=max(N_{BPSCS}(i_{SS})/2,1); floor(*) is a floor function for rounding down; N_{BPSCS}(i_{SS}) is a number of coded bits of each single carrier of the ith spatial stream of the plurality of spatial streams; N_{CBPSS}(i_{SS}) is a number of coded bits of each symbol of the ith spatial stream of the plurality of spatial streams, with N_{CBPSS}(i_{SS})=N_{DATA}×N_{BPSCS}(i_{SS}), and N_{DATA} is a number of carriers; N_{ROT} is a frequency rotation factor; and q is related to a number of the plurality of spatial streams.

The present invention discloses a block interleaver for interleaving data transmitted by a transmitter according to the above block interleaving method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a table of rotation values of spatial streams according to the IEEE 802.11n standard.

FIG. 2 and FIG. 3 are tables of the rotation values of the spatial streams according to an embodiment of the present invention.

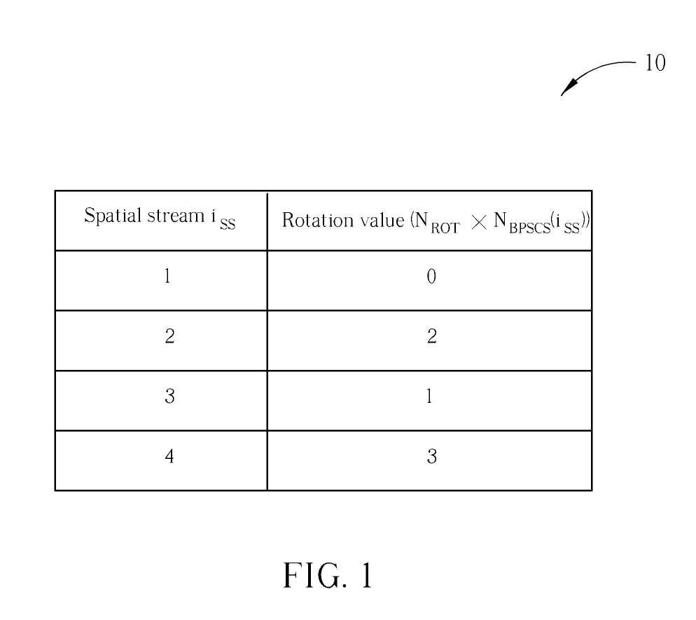

### DETAILED DESCRIPTION

As to a very high throughput (VHT) wireless communication system supporting a multi-input multi-output (MIMO) technique, i.e., a wireless communication system conforming to the IEEE 802.11ac standard, the present invention discloses a cyclic shift value equation, for computing cyclic shift values corresponding to at most 8 spatial streams. The equation is represented as follows:

$$r = ( j - ( ( ( {i}_{SS} - 1 ) \times M ) mod q + q \times floor ( \frac{{i}_{SS} - 1}{q} ) ) \times {N}_{ROT} \times {N}_{BPSCS} ( {i}_{SS} ) ) {mod N}_{CBPSS} ( {i}_{SS} ) ; \\ j = 0 , 1 , … , {N}_{CBPSS} ( {i}_{SS} ) - 1 ; \\ M = 1 , 2 , … , q - 1 ; \text{:} \qquad ( Eq . 2 )$$

where definitions of each parameter and function are the same as those in the prior art. Comparing Eq.1 and Eq.2, the cyclic shift value equation of the present invention adds parameters M and q. The parameter M represents a different combination of different cyclic shift values, and the parameter q is related to a number of spatial streams N_{SS}, which is determined as follows:

(1) When N_{SS}=1, 2, 3, 4, q=3, N_{ROT} is an integer near (N_{DATA}/4). When a channel bandwidth is 20 MHz, 40 MHz or 80 MHz, N_{ROT} is 13, 29 or 59, respectively.

(2) When N_{SS}=5, 6, q=5, N_{ROT} is an integer near (N_{DATA}/6). When a channel bandwidth is 20 MHz, 40 MHz or 80 MHz, N_{ROT} is 9, 18 or 39, respectively.

(3) When Nₛ=7, 8, q=5, N_{ROT} is an integer near (N_{DATA}/8). When a channel bandwidth is 20 MHz, 40 MHz or 80 MHz, N_{ROT} is 7, 13 or 29, respectively.

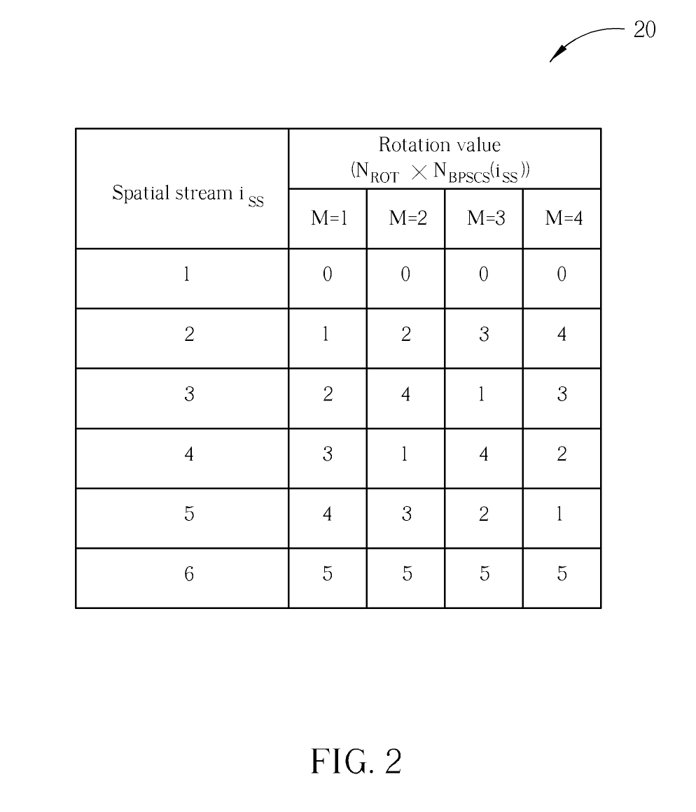

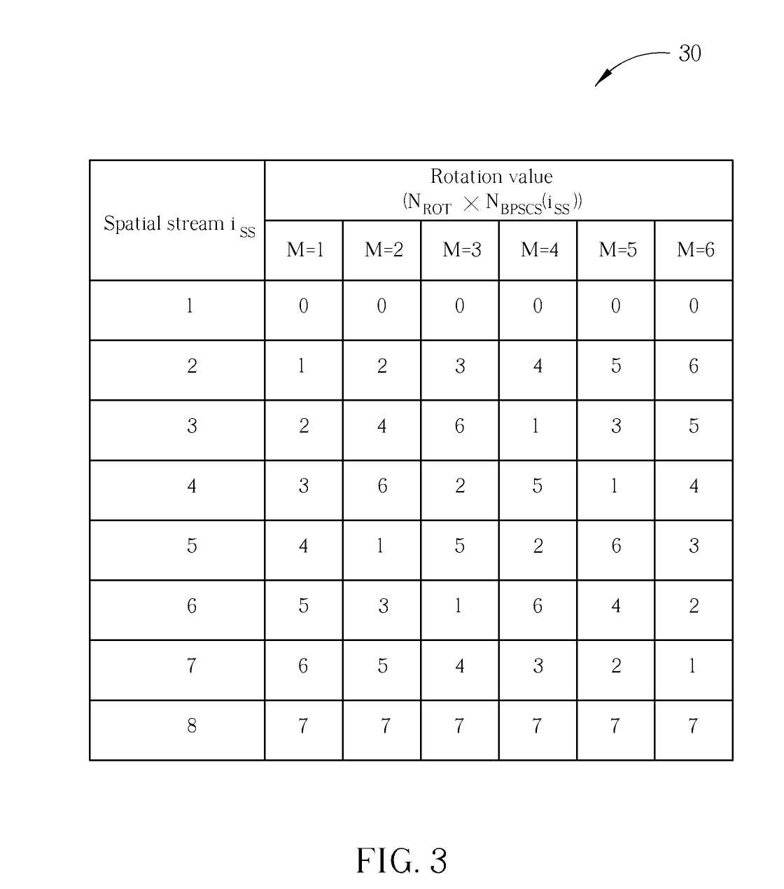

Therefore, according to Eq.2, as to a situation in which a number of the spatial streams is greater than 4, i.e., N_{SS}=5, 6 or N_{SS}=7, 8, corresponding rotation values can be represented by a table 20 shown in FIG. 2 and a table 30 shown in FIG. 3. For simplicity, the rotation values in the tables 20 and 30 are multiples of (N_{ROT}×N_{BPSCS}(i_{SS})). Taking the table 20 as an example, when M=3, the rotation value of the 2nd spatial stream (i_{SS}=2) is (3×N_{ROT}×N_{BPSCS}(3)).

As can be seen from FIG. 2 and FIG. 3, when the number of spatial streams N_{SS} is greater than 4, the present invention provides a combination of different rotation values, to ensure that an interleaved result is dispersive enough. In other words, if a combination of rotation values corresponding to N_{SS}=7, 8 is adopted when N_{SS}=5, 6, the interleaved result is not dispersive enough.

Besides, other than being determined according to the number of spatial streams N_{SS}, N_{ROT} is determined by selecting an integer near but not equal to (N_{DATA}/(q+1)) if N_{DATA} is divisible by (q+1), to reduce a probability of error decision of a deinterleaver. Thus, N_{ROT} is not limited to the abovementioned values, and can be properly adjusted according to system requirements.

On the other hand, as to a realization of the present invention, those skilled in the art can realize Eq.2 in a block interleaver, which is an ordinary skill in the art.

In conclusion, a high throughput wireless local area network (WLAN) supporting more than 4 antennas causes an interleaver structure in the IEEE 802.11n not completely applicable. In comparison to the prior art, the cyclic shift value equation of the present invention determines the cyclic shift value with up to 8 spatial streams, and is suitable for a WLAN standard such as the IEEE 802.11ac standard, to maintain a normal operation of the wireless communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A block interleaving method in a wireless communication system, for interleaving data transmitted by a transmitter, the wireless communication system supporting a multi-input multi-output (MIMO) technique for transmitting data via a plurality of spatial streams, the method comprising:
when the transmitter transmits a plurality of data through the MIMO technique, determining an order of the plurality of data according to the following equation,
$$r = ( j - ( ( ( {i}_{SS} - 1 ) \times M ) mod q + q \times floor ( \frac{{i}_{SS} - 1}{q} ) ) \times {N}_{ROT} \times {N}_{BPSCS} ( {i}_{SS} ) ) {mod N}_{CBPSS} ( {i}_{SS} ) ;$$
$$j = 0 , 1 , … , {N}_{CBPSS} ( {i}_{SS} ) - 1 ;$$
$$M = 1 , 2 , … , q - 1 ;$$
wherein i_{SS} is an ith spatial stream of the plurality of spatial streams;
s(i_{SS})=max(N_{BPSCS}(i_{SS})/2,1);
floor(*) is a floor function for rounding down;
N_{BPSCS}(i_{SS}) is a number of coded bits of each single carrier of the ith spatial stream of the plurality of spatial streams;
N_{CBPSS}(i_{SS}) is a number of coded bits of each symbol of the ith spatial stream of the plurality of spatial streams, with N_{CBPSS}(i_{SS})=N_{DATA}×N_{BPSCS}(i_{SS}), and N_{DATA} is a number of carriers;
N_{ROT} is a frequency rotation factor; and
q is related to a number of the plurality of spatial streams.

2. The block interleaving method of claim 1, wherein the wireless communication system conforms to an IEEE 802.11 standard.

3. The block interleaving method of claim 1, wherein N_{ROT} is an integer near (N_{DATA}/6) and q is 5, when the number of the plurality of spatial streams is 5 or 6.

4. The block interleaving method of claim 3, wherein N_{ROT} is 9 when a channel bandwidth of the wireless communication system is 20 MHz, N_{ROT} is 18 when the channel bandwidth of the wireless communication system is 40 MHz, and N_{ROT} is 39 when the channel bandwidth of the wireless communication system is 80 MHz.

5. The block interleaving method of claim 1, wherein N_{ROT} is an integer near (N_{DATA}/8) and q is 7, when the number of the plurality of spatial streams is 7 or 8.

6. The block interleaving method of claim 5, wherein N_{ROT} is 7 when the channel bandwidth of the wireless communication system is 20 MHz, N_{ROT} is 13 when the channel bandwidth of the wireless communication system is 40 MHz, and N_{ROT} is 29 when the channel bandwidth of the wireless communication system is 80 MHz.

7. A block interleaver for interleaving data transmitted by a transmitter according to the block interleaving method of claim 1.
